(19) United States
(12) Patent Application Publication
(10) Pub. No.: US 2022/0292891 A1
(43) Pub. Date: Sep. 15, 2022

(54) Advanced flight control subsystem

(71) Applicant: Shih-li Charles Wang, Hyde Park, NY (US)

(72) Inventor: Shih-li Charles Wang, Hyde Park, NY (US)

(73) Assignee: Shih-li Charles Wang, Hyde Park, NY (US)

(21) Appl. No.: 17/300,122

(22) Filed: Mar. 15, 2021

(51) Int. Cl. G07C 5/08; G08G 5/00

(52) U.S. Cl. CPC G07C 5/0816; G08G 5/003; G08G 5/0013

(57) ABSTRACT

Per United States Federal Aviation Administration (FAA)'s long standing airworthiness regulation, Advisory Circular (AC), failures of all systems/components that are catastrophic must be “extremely improbable”. Advanced Flight Control Subsystem shall supplement current commercial passenger aircrafts' Flight Control Computers (FCC) to meet and exceed this requirement.

### FIELD

A component of modern aircrafts, which enhances the flight control system, or Flight Control Computer(s), by incorporating hardware, sensors, software, computer algorithms, firmware to ensure probability of error of flight control system is extremely improbable, or almost impossible.

### BACKGROUND

Modern aircraft relies heavily on sensors to fly at night, low visibility conditions, in bad weathers, at high altitude. More automation, Flight Control Computers (FCC) requires more accurate and reliable information. Many of these tasks are not even possible for older aircrafts to perform. Flight control system uses multitude of information to make decision for flying safety. Advanced Flight Control Subsystem takes on some of the challenges, especially for aircrafts been designed before flying in above-mentioned extreme conditions became routine.

### SUMMARY

FAA requires critical components such as Flight Control software to be extremely improbable to fail. However, different type of sensors feeding information to flight control computer have different probability of failure rate. For example, Angle of Attack (AOA) sensors have very high probability of failure due to their location been on the outside of the fuselage and they are physical, mechanical devises. Advanced Flight Control Subsystem uses a variety of hardware, software, computer algorithms to address weakness in each different area.

### SPECIFICATION

FAA Advisory Circular (AC) describes acceptable means for showing compliance with the airworthiness requirement of AC 25.1309 of the Federal Aviation Regulations. In his case the more severe the hazard resulting from a system or equipment (component) failure, the less likely that failure must be. Thus, failures that are catastrophic must be extremely improbable, or probability of failure equivalent of 10\hat{ }−9, or less.

The airworthiness requirement for transport category airplanes is contained in the Title 14, code of Federal Regulations (14 CFR) part 25, also referred to as part 25 of the Federal Aviation Regulations (FAR). Manufacturers of transport category airplanes must show that each airplane they produce of a given type design complies with the relevant standards of part 25.

According to the Boeing 737 Max jetliners crashed on Oct. 29, 2018 and on M14, 2019, only 136 days apart, approximately 310 such aircrafts were in service at the time, 2 to 3 estimated number landing/takeoff each day, we can calculate the probability of catastrophic failure rate is much larger than the required “extremely improbable”, >>10\hat{ }−9. If fact, it's order of magnitude higher than what's considered acceptable.

It has been more than two years since both accidents happened. Besides pilots training, fixes of Maneuvering Characteristic Augmentation System (MCAS) and other related actions taken by Boeing, two (2) AOA sensors and “Synthetic Airspeed” are implemented supposedly to strengthen the root of the cause of the accidents. However, this is not enough to address the problem at hand.

When either one of the sensors, one on the right or the other on the left, malfunctions, angle-of-attack of air flow may become too great and rendering the aircraft going into a stall. Airspeed drops happens after-the-fact of pending stall and piolets are left seconds to react to the a likely catastrophic event. When airspeed is slowed down due to air hitting the underside of the fuselage and airfoils will not generate proper lift for the airplane to fly in the air. This can be extremely dangerous especially when the visibility is low, at night or bad weather conditions.

Advanced Flight Control Subsystem accompanied by enabling devices (see attached diagram) shall eliminate such ambiguity of flight control to reduce probability of failure to 10\hat{ }−9, or much less than 10\hat{ }−9 (= or <<10\hat{ }−9). Thus, meet and exceed FAA's AC 25.1309 regulation.

### REPLACEMENT DRAWING

### Brief Description of Diagram

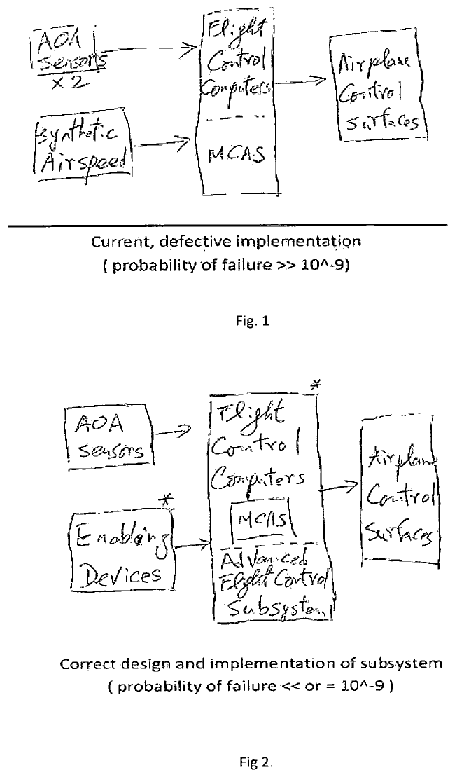

FIG. 1 In a possible scenario, a hypothetical airplane manufacturing company may have decided to use two (2) AOA sensors and synthetic airspeed to simulate airflow around certain type of airplane. However, from actual statistical data and proper logic, the probability of failure of this type of arrangement will not meet FAA's requirement for critical component (flight control) of an aircraft.

FIG. 2 Advanced Flight Control Subsystem will use artificial intelligence (AI), predicate calculus, correct logic, and computer algorithm(s) in combination with hardware enabling devices to provide accurate information to flight control computer (FCC) meeting or exceeding the FAA requirement probability of error for critical component(s), lower than 10\hat{ }−9 or far less than 10\hat{ }−9.

I. Advanced Flight Control Subsystem consists of hardware, software, firmware components using algorithm(s) to provide Flight Control Computer (FCC) accurate information to operate modern aircrafts. In case of single or multiple components failure Advanced Flight Control Subsystem will continue to operate in order to achieve 10\hat{ }−9, or far less than 10\hat{ }−9 level of probability of flight control system error.
